(19) United States
(12) Patent Application Publication
(10) Pub. No.: US 2026/0004217 A1
(43) Pub. Date: Jan. 1, 2026

(54) INDUSTRIAL MAINTENANCE PLANNING AND TRACKING

(71) Applicant: Rockwell Automation Technologies, Inc., Mayfield Heights, OH (US)

(72) Inventors: Liudmila Domakhina, Toronto (CA); Mohammad Esmalifalak, Toronto (CA); Chatheersh Sivakumaran, Toronto (CA); Min Hua Yu, Toronto (CA); Hyo Jung S Son, Calgary (CA); Ashish Mistry, Toronto (CA); Tareq Al-Masri, Toronto (CA)

(21) Appl. No.: 18/755,323

(22) Filed: Jun. 26, 2024

(51) Int. Cl. G06Q 10/0633; G01C 21/20; G06Q 10/0631

(52) U.S. Cl. CPC G06Q 10/0633; G01C 21/206; G06Q 10/063114; G06Q 10/063116

(57) ABSTRACT

A work order tracking system analyzes asset and work order data and provides a range of insights relating to asset performance and maintenance, including asset downtime statistics, maintenance efficiency, asset-specific financial information, and other such insights. Embodiments of the work order tracking system can also provide proactive recommendations and guidance for carrying out open work orders in a manner that improves or optimizes maintenance efficiency and effectiveness.

### BACKGROUND

The subject matter disclosed herein relates generally to industrial maintenance, and, more specifically, to industrial work order tracking and planning.

### BRIEF DESCRIPTION

The following presents a simplified summary in order to provide a basic understanding of some aspects described herein. This summary is not an extensive overview nor is it intended to identify key/critical elements or to delineate the scope of the various aspects described herein. Its sole purpose is to present some concepts in a simplified form as a prelude to the more detailed description that is presented later.

In one or more embodiments, a system is provided, comprising a memory that stores executable components and work order data defining work orders for maintenance tasks performed on industrial assets within an industrial facility, where the executable components comprise a monitoring component configured to, for a work order of the work orders, monitor a duration of time spent by a technician to execute a maintenance task defined by the work order; an analysis component configured to record the amount of time in association with the work order as part of the work order data, and to generate maintenance statistic data based on analysis of the work order data from the work orders; and a user interface component configured to render, on a client device, an interface that displays the maintenance statistic data in a graphical format.

Also, one or more embodiments provide a method, comprising storing, by a system comprising a processor, work orders for maintenance tasks performed on industrial assets within an industrial facility; for a work order of the work orders, monitoring, by the system, a duration of time spent by a technician to execute a maintenance task defined by the work order; recording, by the system, the amount of time in association with the work order as part of the work order data; generating, by the system, maintenance statistic data based on analysis of the work order data; and rendering, by the system on a client device, an interface that displays the maintenance statistic data in a graphical format.

Also, according to one or more embodiments, a non-transitory computer-readable medium is provided having stored thereon instructions that, in response to execution, cause a system to perform operations, the operations comprising storing work orders for maintenance tasks performed on industrial assets within an industrial facility; for a work order of the work orders, tracking a duration of time spent by a technician to execute a maintenance task defined by the work order; recording the amount of time in association with the work order as part of the work order data; generating maintenance statistic data based on analysis of the work order data; and rendering, on a client device, an interface that displays the maintenance statistic data in a graphical format

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of a work order tracking system.

FIG. 3 is a block diagram of a work order tracking system.

FIG. 4 is a diagram illustrating an example architecture for automatically generating work orders based on analysis of real-time or historical industrial asset performance.

FIG. 5 is a diagram illustrating training of models used by some embodiments of the work order tracking system.

FIG. 6 is a diagram illustrating generation of maintenance statistics that quantify an industrial enterprise's maintenance activities based on analysis of open and closed work orders.

FIG. 7 is a diagram illustrating delivery of maintenance tracking and planning interfaces to a client device by the work order tracking system.

FIG. 8 is an example interface that renders a plot of calculated maintenance efficiency as a percentage over time, and an Overview window that lists industrial assets on which maintenance was performed together with maintenance statistics for each asset.

FIG. 9a is an example interface that renders a plot of a maintenance efficiency trend over time, and a portion of a summary window that displays accumulated maintenance statistics for the previous month.

FIG. 9b is another view of the interface that depicts more information included in the summary window.

FIG. 10 is an example interface that renders information on currently active or open work orders.

FIG. 11 is an example asset selection window that can be rendered by user interface component and used to manually select assets whose maintenance statistics are to be tracked and displayed on dashboard.

FIG. 12 is a diagram of an example architecture in which a technician's activities are tracked by the system.

FIG. 13 is a flowchart an example methodology for tracking maintenance statistics within an industrial facility.

FIG. 14 is a flowchart an example methodology for planning and optimizing maintenance routes for technicians within an industrial facility.

FIG. 15 is a flowchart an example methodology for automatically initiating a work order for maintenance being performed on an industrial asset and to retroactively track the cumulative time spent on the maintenance.

FIG. 16 is an example computing environment.

FIG. 17 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial controllers, their associated I/O devices, motor drives, and other such industrial devices are central to the operation of modern automation systems. Industrial controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such platforms.

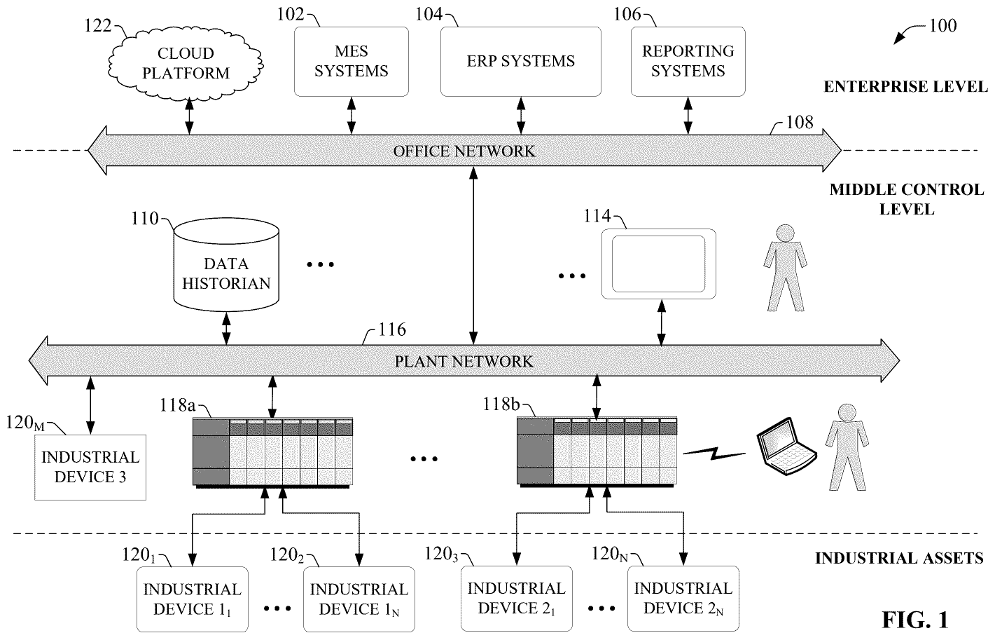

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like. Some industrial devices, such as industrial device 120M, may operate autonomously on the plant network 116 without being controlled by an industrial controller 118.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over the plant network 116 using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMIs 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on an office network 108 or on a cloud platform 122. These higher level systems can include, for example, enterprise resource planning (ERP) systems 104 that integrate and collectively manage high-level business operations, such as finance, sales, order management, marketing, human resources, or other such business functions. Manufacturing Execution Systems (MES) 102 can monitor and manage control operations on the control level in view of higher-level business considerations, driving those control-level operations toward outcomes that satisfy defined business goals (e.g., order fulfillment, resource tracking and management, asset utilization tracking, etc.). Reporting systems 106 can collect operational data from industrial devices on the plant floor and generate daily or shift reports that summarize operational statistics of the controlled industrial assets

Industrial facilities typically house and operate many industrial assets, machines, or equipment. Many of these assets require regular proactive maintenance to ensure continued optimal operation, in addition to unplanned repair operations to address unexpected downtime events, such as machine malfunctions. To manage the large number of maintenance operations carried out at a given industrial enterprise, work order tracking systems can be used to initiate work orders for new maintenance operations to be performed and to track the statuses of these work orders. Maintenance technicians or managers can fill out and submit work orders for respective maintenance operations or tasks to the system. A work order typically remains open as its corresponding maintenance task is performed, and is then closed once the task is completed.

However, the functionality of such work order management systems is typically limited to work order submission and crude status tracking, with no ability to offer higher-level insights into how well maintenance operations are being performed within a given industrial facility or across multiple facilities of an industrial enterprise. Conventional work order management systems also fail to offer high level maintenance planning assistance or recommendations for optimizing the efficiency or effectiveness of maintenance activities.

To address these and other issues, one or more embodiments described herein provide a work order tracking system that analyzes asset and work order data and provides a range of insights relating to asset performance and maintenance, including asset downtime statistics, maintenance efficiency, asset-specific financial information, and other such insights. Embodiments of the work order tracking system can also provide proactive recommendations and guidance for carrying out open work orders in a manner that improves or optimizes maintenance efficiency and effectiveness.

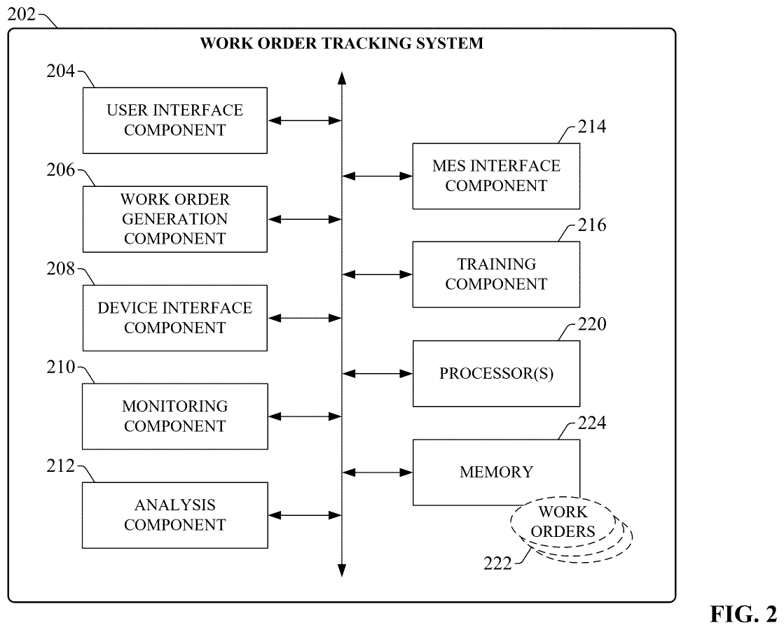

FIG. 2 is a block diagram of a work order tracking system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Work order tracking system 202 can include a user interface component 204, a work order generation component 206, a device interface component 208, a monitoring component 210, an analysis component 212, an MES interface component 214, a training component 216 one or more processors 220, and memory 224. In various embodiments, one or more of the user interface component 204, work order generation component 206, device interface component 208, monitoring component 210, analysis component 212, MES interface component 214, training component 216, the one or more processors 220, and memory 224 can be electrically and/or communicatively coupled to one another to perform one or more of the functions of the work order tracking system 202. In some embodiments, components 204, 206, 208, 210, 212, and 214, can comprise software instructions stored on memory 224 and executed by processor(s) 218. Work order tracking system 202 may also interact with other hardware and/or software components not depicted in FIG. 2. For example, processor(s) 220 may interact with one or more external user interface devices, such as a keyboard, a mouse, a display monitor, a touchscreen, or other such interface devices.

User interface component 204 can be configured to generate user interface displays that receive user input and render output to the user in any suitable format (e.g., visual, audio, tactile, etc.). In some embodiments, user interface component 204 can render these interface displays on a client device (e.g., a laptop computer, tablet computer, smart phone, etc.) that is communicatively connected to the work order tracking system 202 (e.g., via a hardwired or wireless connection). Input data that can be received via user interface component 204 can include, but is not limited to, work order data (e.g., work order data field entries), user interface navigation input, or other such input data. Output data rendered by user interface component 204 can include, but is not limited to, information regarding closed and open work orders, maintenance planning recommendations or guidance, recommended workflows for performing a maintenance task defined by a work order, results of maintenance tracking analysis, optimized maintenance routes, or other such output data.

Work order generation component 206 can be configured to generate work orders 222 based on user-submitted information about a maintenance task to be performed, or based on detected or predicted asset risks. In some embodiments, the work order generation component 206 can generate work orders and schedule corresponding maintenance tasks based on analysis performed by the analysis component 212, which can also be assisted using generative AI.

Device interface component 208 can be configured to interface with industrial devices or assets on the plant floor, either directly or via a gateway or edge device, and receive real-time operational and status data from these assets for the purposes of asset health monitoring and analysis. Monitoring component 210 can be configured to monitor specified sets of the collected industrial data for conditions indicative of a performance issue requiring investigation or maintenance. In some embodiments, the sets of industrial data to be monitored, as well as the conditions of this data that indicate a performance concern that requires a maintenance task to be scheduled, can be defined by machine-specific asset models for the industrial equipment being monitored, can be determined or defined by the system 202 based on analysis of the assets' performance over time, or can be manually configured by an administrator of the system 202. The monitoring component 210 can also monitor certain human behaviors, such as those performed by maintenance personnel in connection with performing maintenance tasks associated with respective work orders 222.

Analysis component 212 can be configured to perform analysis on real-time or historical asset performance data, data obtained from an MES system or a similar high-level enterprise tracking system, contextual information, or other such data to determine when maintenance tasks are to be scheduled, what those maintenance tasks include, and which technicians are to be assigned the tasks. In some embodiments, the analysis component 212 can apply AI or generative AI-assisted analysis to this data in connection with determining when and how maintenance tasks should be scheduled and corresponding work orders generated. Analysis component 212 can also generate statistical data for maintenance activities based on analysis of closed work orders 222 together with maintenance data (collected by the monitoring component 210) that quantifies maintenance activities performed to carry out those work orders 222. Analysis component 212 can also formulate substantially optimized workflows, maintenance schedules, or technician assignments for performing maintenance activities on open work orders 222.

MES interface component 214 can be configured to retrieve, from an MES system or another source of industrial enterprise data, information that can be used by the analysis component 212 to determine when maintenance tasks should be scheduled, which technicians should be assigned the tasks, the nature of the maintenance tasks that should be performed to mitigate a detected risk, optimized workflows or routes for carrying out a scheduled maintenance task, or other such determinations. In some embodiments, the MES interface component 214 can also initiate transmission of notifications to appropriate personnel via the MES in conjunction with generation of work orders 222. Training component 216 can be configured to train one or more trained models with various types of relevant training data. These trained models are used by the system 202 in connection with identifying asset risk conditions that require scheduling of a maintenance action, generating maintenance and performance statistics and insights for customers' industrial assets, and other such functions.

The one or more processors 220 can perform one or more of the functions described herein with reference to the systems and/or methods disclosed. Memory 224 can be a computer-readable storage medium that stores computer-executable instructions and/or information for performing the functions described herein with reference to the systems and/or methods disclosed. Memory 224 can also store the work order data submitted by users as work orders 222.

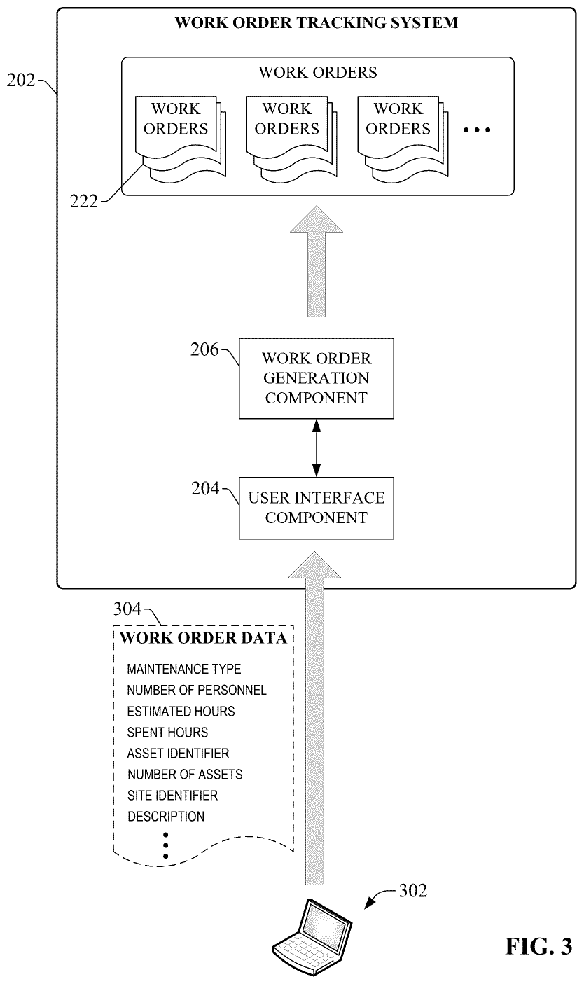

FIG. 3 is a diagram illustrating generation of work orders 222 using the work order tracking system 202. Work order tracking system 202 can be implemented on any suitable platform that allows the system 202 to be accessed via client devices 308 (e.g., desktop computers, laptop computers, smart phones, tablet computers, wearable computing devices, etc.). For example, system 202 can be executed on a cloud platform as a set of cloud-based services, allowing multiple customer entities across multiple industrial facilities to access the system 202 and initiate work orders 222, view work orders 222, or view work order analysis results. System 202 can also be executed on a public network such as the internet and made accessible to users having suitable authorization credentials. In such embodiments, the system 202 can maintain work orders 222 for different industrial enterprises in a segregated manner, such that employees of a given industrial enterprise can only access work orders and associated analysis results associated with that enterprise.

The user interface component 204 can allow client devices 302 to communicatively interface with the work order tracking system 202 and submit work order data 304. This work order data 304 can represent either a newly initiated work order for a maintenance task to be performed, or updated information for an open work order 222 that was previously submitted to the system 202. Substantially any work order format can be supported by various embodiments of work order tracking system 202. In an example scenario, user interface component 204 can generate and deliver, to the client device 302, user interface displays comprising editable data fields representing features of the maintenance job represented by the work order 222. Items of work order data 304 that can be submitted to the system 202 in this manner can include, but are not limited to, a type of maintenance to be performed, a description of the maintenance, the number of personnel required to perform the maintenance, an estimated number of hours to perform the maintenance, an actual number of hours spent on the job, identities and numbers of industrial assets that are subject to the maintenance, identities of industrial sites or facilities in which the maintenance takes place, materials to be used to perform the job, an expected cost to perform the job (e.g., costs of replacement parts), or other such information.

Embodiments of the work order management system 202 are not limited to submission of work order data 304 via such user interfaces. For example, in some embodiments the system 202 can allow the user to submit work order data 304 as natural language text or speech via a chat interface rendered by the system 202. In such embodiments, the work order generation component 206 can translate this natural language input to corresponding work order data 304 which is then used to populate the content of the relevant work order 222.

Based on submitted work order data 304 describing a reactive or proactive maintenance task to be performed, work order generation component 206 can generate a work order 222 containing information about the maintenance task (or set of tasks) to be performed. The system 202 can classify each work order 222 as either an open work order representing a pending maintenance job to be performed on one or more industrial assets (e.g., machines, production lines, industrial devices, etc.) or a closed work order representing a maintenance job that has been completed.

Creation of work orders 222 via manual submission of work order data 304 by plant personnel, as illustrated in FIG. 3, can be suitable for initiating work orders 222 for reactive maintenance tasks, in which the maintenance tasks are intended to address an unexpected asset performance problem or risk condition. Additionally or alternatively, some embodiments of the work order tracking system 202 can generate some types of work orders 222 automatically according to a defined maintenance schedule. For example, the work order generation component 206 can be configured to automatically generate and schedule work orders 222 for proactive or scheduled maintenance tasks designed to prolong an industrial asset's lifecycle or to proactively prevent asset failures or performance inefficiencies. These proactive maintenance actions can include, for example, oil changes, inspection routines, proactive replacement of parts at regular intervals, or other such scheduled maintenance tasks. The system 202 can generate and schedule these proactive work orders 222 at regular or semi-regular intervals according to a defined frequency at which the maintenance is to be conducted.

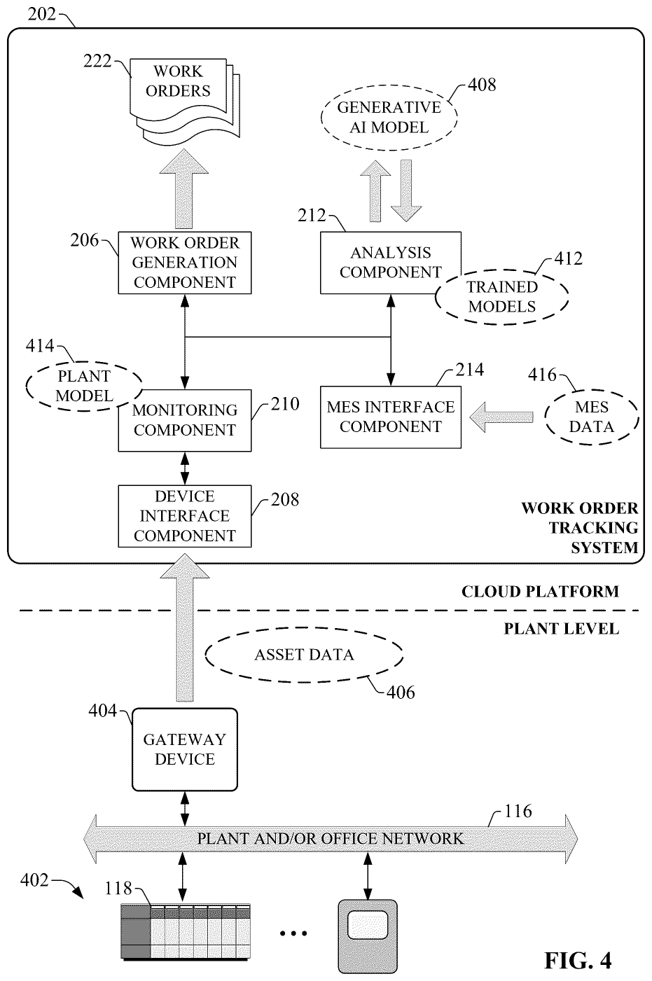

Also, some embodiments of the system 202 can automatically generate reactive work orders 222 in response to real-time detection of an asset performance issue. FIG. 4 is a diagram illustrating an example architecture for automatically generating work orders 222 based on analysis of real-time or historical industrial asset performance. In the example architecture of FIG. 4, a gateway device 404 resides on the same plant network 116 as the industrial devices 402 associated with automation systems on the plant floor. These industrial devices 402 can include, for example, industrial controllers 118, motor drives, HMI terminals, telemetry devices (e.g., flow meters, pressure meters, temperature meters, etc.), sensors of various types (e.g., photo-sensors, proximity sensors, etc.), or other such devices. The automation systems and their associated industrial devices 402, machines, and machine components constitute industrial assets for which reactive or proactive maintenance may be scheduled as needed. During operation of the plant's automation systems, gateway device 404 collects asset data 406 from industrial devices 402. This data can include data values read from data tags, data registers, or automation objects defined on one or more industrial controllers 118; data from analog or digital sensors; data from telemetry devices or meters, or other such data. In general, asset data 406 represents status, operational, or performance data for the industrial assets.

In some embodiments, gateway device 404 can contextualize the collected data 406 prior to delivering the data to the work order tracking system 202 and deliver the processed data to the system 202 as contextualized data. This contextualization can include time-stamping the data, as well as normalizing or otherwise formatting the collected data for analysis by the work order tracking system 202. In general, gateway device 404 serves as an edge device that interfaces data from the set of industrial devices 402 to either the work order tracking system 202 or a separate data storage platform accessible to the work order tracking system 202.

Although FIG. 4 depicts a scenario in which the system 202 collects and processes asset data 406 from only a single facility owned by a single customer, the work order tracking system 202 is scalable across multiple industrial facilities. In this regard, the system 202 can serve as a single platform that provides work order generation, maintenance tracking, and maintenance insight services for multiple industrial customers. To achieve this scalability, the system 202 can maintain segregation of respective customer's proprietary data, and can also execute separate instances of the system's services and models 412 for the respective customers.

The work order tracking system's device interface component 208 can remotely interface with the gateway device 404 to receive the collected asset data 406, and the system's monitoring component 210 can monitor the asset data 406 for conditions indicative of a possible performance issue that necessitates a maintenance action and creation of a corresponding work order 222. In some embodiments, rather than obtaining asset data 406 from the industrial assets (e.g., industrial devices 402 and their associated machines or automation systems) via an integrated device interface component 806, the system's monitoring component 210 may access other sources of real-time or historical asset data 406 generated by the industrial assets within the plant facility, such as a data historian system, a data lake, or other such systems. Robots can also be used to provide at least some of the asset data 406, which can be used by the system 202 in connection with identifying asset performance issues and generating work orders. For example, inspection robots can traverse inspection routes and collect machine states (e.g., via infrared panel scans, meter readings, etc.) and feed this information to the work order tracking system 202 as asset data 406.

When the monitoring component 210, assisted by the analysis component 212, determines that the monitored asset data 406 satisfies a condition indicative of a current or predicted asset performance issue requiring investigation or correction by maintenance personnel, system's work order generation component 206 can schedule one or more maintenance tasks predicted to correct the performance issue and generate a corresponding work order 222 for the tasks. The condition detected by the monitoring component 210 that triggers creation of a work order 222 can be, for example, a deviation of one or more data tag values that move outside a defined range of normal or expected values, or a deviation of a trend of these data tag values from a learned trend indicative of normal or acceptable asset performance. In an example scenario, a baking process may require an oven temperature to stay within a defined temperature range. Accordingly, values of a data tag or automation object corresponding to this oven temperature can be collected from the industrial controller 118 that monitors and controls the baking process, and this collected data can be provided to the work order tracking system 202 as part of the asset data 406. The monitoring component 210 monitors this value to determine when the oven temperature deviates from this range and, in response to detecting such a deviation, instructs work order generation component 206 to generate a new open work order 222 for investigation of the temperature control issue. In some embodiments, machine-specific asset models maintained on the work order tracking system 202 can define which data items or performance parameters of the industrial assets are to be monitored, as well as the conditions of this data that are to trigger creation of work orders 222. In other embodiments, the system 202 can learn to recognize conditions of the asset data indicative of an elevated risk to an asset using machine learning, AI, generative AI, or other analytic techniques.

In some scenarios in which a given machine performance metric is a function of the current states of other performance metrics, the condition that triggers creation of a work order 222 can be based on a holistic set of data value conditions rather than being based on deviation of a single data value. For example, an expected value of a given performance metric for a machine or automation system—e.g., a conveyor speed, an oven temperature, a fill level, etc.—may depend on the current operating mode of the machine, a speed or temperature of another machine component, or other such factors. The value of the performance metric may also be seasonal or time-specific, such that the expected value of the metric depends on a current time of day, a current day of the week, a current month of the year, or another time function. If the health of a machine or automation system is a function of whether concurrent values of multiple data tags are within an expected holistic value space, the monitoring component 210 can be configured to instruct the work order generation component 206 to generate a work order 222 upon determining that these values are in a collective, concurrent state indicating a potential performance problem.

A work order 222 generated by the work order generation component 206 can contain information about the maintenance task to be performed, including but not limited to an identity of the industrial asset or machine for which maintenance is required, an aspect of the industrial asset that requires attention, a type of the maintenance to be performed, an estimated number of hours to be spent on the maintenance task, an estimated number of personnel to be assigned to the task, a description of the task, or other such information. The work order 222 is initially scheduled in the system 202 as an open work order 222 (that is, the system 202 stores the work order 222 as work order data in memory 224 and assigns an “Open” status to the work order 222) and remains open until completion of its associated maintenance tasks, at which time the system 202 assigns a “Closed” status to the work order 222. Authorized users can browse and view both open and closed work orders 222 via user interface component 204.

Some embodiments of the work order tracking system 202 can reference information about the industrial assets in use within a plant facility, and the functional or geographic relationships between these assets, in connection with determining when to schedule maintenance activities or generating maintenance planning and tracking data (as will be described in more detail below). In some embodiments, this information can be maintained in a plant model 414 that defines industrial machines, systems, or assets within the plant facility as well as the functional or geographical relationships between those assets. For example, the plant model 414 may define the relative locations of respective machines or automation systems within the plant, functional relationships between the machines (e.g., interdependencies between the machines or systems, such as indications of which automation systems are responsible for providing material or parts to other downstream systems), or other such asset information.

To facilitate intelligent automated generation of work orders 222, the monitoring component 210 can be assisted by an analysis component 212 in some embodiments. The analysis component 212 that can apply one or more types of analysis (e.g., artificial intelligence (AI), generative AI analysis or generative AI-assisted analysis, machine learning, etc.) to real-time or historical asset data 406, MES data 416 from the plant facility's MES system or another high-level plant managements system, and other contextual data in connection with determining when to schedule maintenance tasks, what these maintenance tasks entail, and which technicians are to be assigned the tasks. For example, in some embodiments, the analysis component 212 can leverage generative AI to automatically generate work orders 222 or otherwise schedule maintenance tasks based on predicted or detected asset risks. In such embodiments, the analysis component 212 can be configured with prompt engineering functionality using associated trained models 412 trained with various types of training data, and can use these prompt engineering features to interface with a generative AI model 408 (e.g., a large language model (LLM) or another type of model) and associated neural networks.

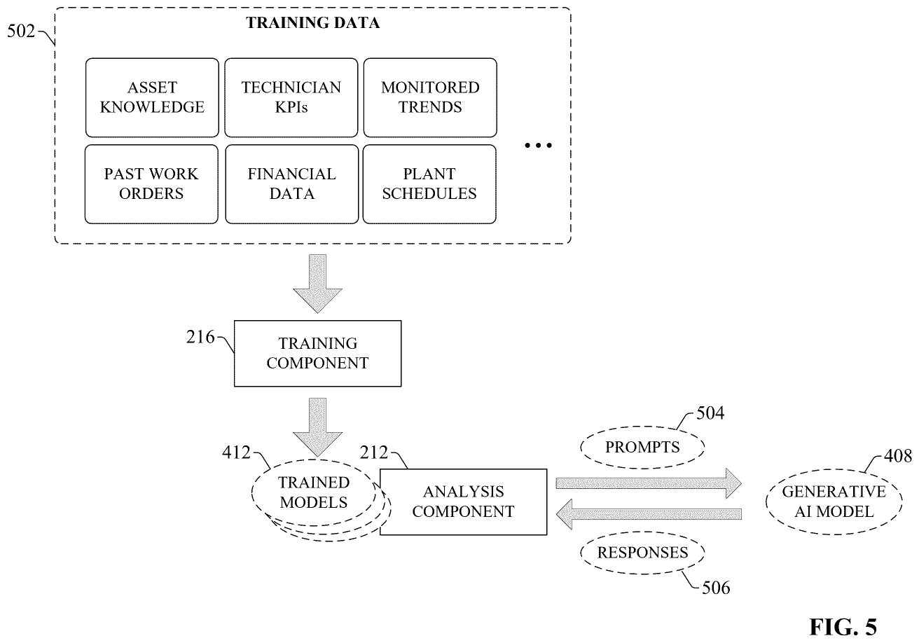

FIG. 5 is a diagram illustrating training of the models 412 used by some embodiments of the analysis component 212. The system's training component 216 can train models 412 using training data 502 relevant to identification or prediction of risks to the plant facility's industrial assets, scheduling of suitable maintenance tasks for mitigating the risks, and assignment of those maintenance tasks to suitable technicians. Such training data 502 can include, but is not limited to, knowledge or technical specifications of industrial assets, machines, and devices that are in service within the industrial facility; information from past or closed work orders 222; monitored trends in asset operation (e.g., histories and frequencies of asset failure); information about technicians employed by the plant facility (e.g., employee identities, skill sets, work histories relative to specific assets or types of maintenance tasks, work schedules etc.); financial data for the plant facility; or other such data 502.

The monitoring component 210 and analysis component 212 can detect a current asset risk condition (or predict a future asset risk condition) that requires scheduling of a maintenance task and generation of a corresponding work order 222 based on analysis of real-time or historical asset data 406 as well as content of the trained models 412. In some scenarios, this analysis can be performed without accessing the generative AI model 408. However, the analysis component 212 can also, as needed, interact with the generative AI model 408 as part of the risk detection analysis, or as part of the work order generation process. For example, as the work order tracking system 202 is monitoring asset data 406 for risk conditions, the analysis component 212 can determine whether a given subset of the asset data 406 generated by an industrial asset or related groups of assets is indicative of a risk condition based on knowledge of the relevant industrial assets (e.g., values of performance indicators known or inferred to correlate with a risk condition for those specific assets, the nature of the risk condition indicated by anomalous values of those performance indicators, lifecycle information for the assets, etc.), and this asset knowledge can be obtained from technical asset information encoded in the trained models 412 as part of training data 502 or can be prompted from the generative AI model 408 using suitable prompts 504 generated by the analysis component 212.

Similarly, when an asset risk is detected, the analysis component 212 can determine a suitable set of maintenance tasks for mitigating the detected or predicted risk based on the training data 502 encoded in the models 412, as well as responses 506 prompted from the generative AI model 408. Responses 506 prompted from the generative AI model 408 can also be used by the work order generation component 206 to generate natural language content to be included in the corresponding work order 222 (e.g., natural language descriptions of the asset risk, natural language descriptions of the maintenance tasks rendered, etc.).

In the scenarios described above, the analysis component 212 may prompt the generative AI model 408 for supplemental information in response to determining that additional information from the generative AI model 408 would yield an analytic result having a higher probable level of accuracy relative to relying solely on the asset data 406 and trained models 412 alone. To support generative AI-assisted generation and scheduling of work orders 222, the analysis component 212 can be configured with custom prompt engineering capabilities designed to prompt the generative AI model 408 for supplemental information that can be used by the work order tracking system 202 to recognize industrial asset risk conditions, infer suitable corrective maintenance tasks for mitigating asset-specific risks, and generate content of a work order 222 for the maintenance tasks.

During the asset monitoring process, the analysis component 212 can formulate and submits prompts 504 to the generative AI model 408 designed to obtain responses 506 that can assist with monitoring the performance of industrial assets for risk conditions, formulating maintenance strategies for mitigating the risk conditions, or generating content of a work order 222. The analysis component 212 can generate these prompts 504 based on a current operating context of one or more industrial assets being monitored (as determined from real-time or historical asset data 406) as well as the training data 502 encoded in the trained models 412. The analysis component 212 can reference the trained models 412 or associated training data 502 as needed in connection with creating prompts 504 designed to obtain responses 506 from the generative AI model 408 that assist the analysis component 212 in recognizing a current or predicted risk to an industrial asset, formulating a maintenance intervention for mitigating the risk, or generating content of a work order 222 for scheduling the maintenance intervention (e.g., natural language summaries of the identified asset risk, as well as descriptions of the maintenance tasks for mitigating the risk). The analysis component 212 can generate the prompt 504 to include any relevant information that can assist the generative AI model 408 in converging on a useful responses 506 that can be used to better understand a current context of the industrial assets, including but not limited to a selected subset of the asset data 406 itself, the type of industrial asset of interest (e.g., a type of machine or industrial device), an indication of the type of industrial process or application being carried out by the industrial asset of interest (e.g., a specific type of batch processing, a specific automotive manufacturing function, a sheet metal stamping application, etc.), any selected subsets of the training data 502 or MES data 416, or other such data.

The techniques described above for generating or initiating a work order 222 within the work order tracking system 202 are only intended to be exemplary, and it is to be appreciated that substantially any technique for initiating a work order 222 using work order tracking system 202 are within the scope of one or more embodiments of this disclosure.

In some embodiments, the trained models 412 can include one or more predictive models that are trained by the training component 216 to forecast or predict future performance issues or failure risks for the industrial assets. The training component 216 can automatically train these predictive models using machine learning algorithms applied to asset data 406 collected from the assets over time, from which the predictive models can learn performance trends for individual industrial assets and use these trends to predict future performance issues. The work order management system 202 can use these predictive models to identify potential future asset failures or performance degradations, and to automatically generate work orders 222 for maintenance activities designed to mitigate these issues in response to these predictions. The predictive models can also be used by the system 202 to forecast future maintenance statistics for the assets for reporting purposes, as will be described below.

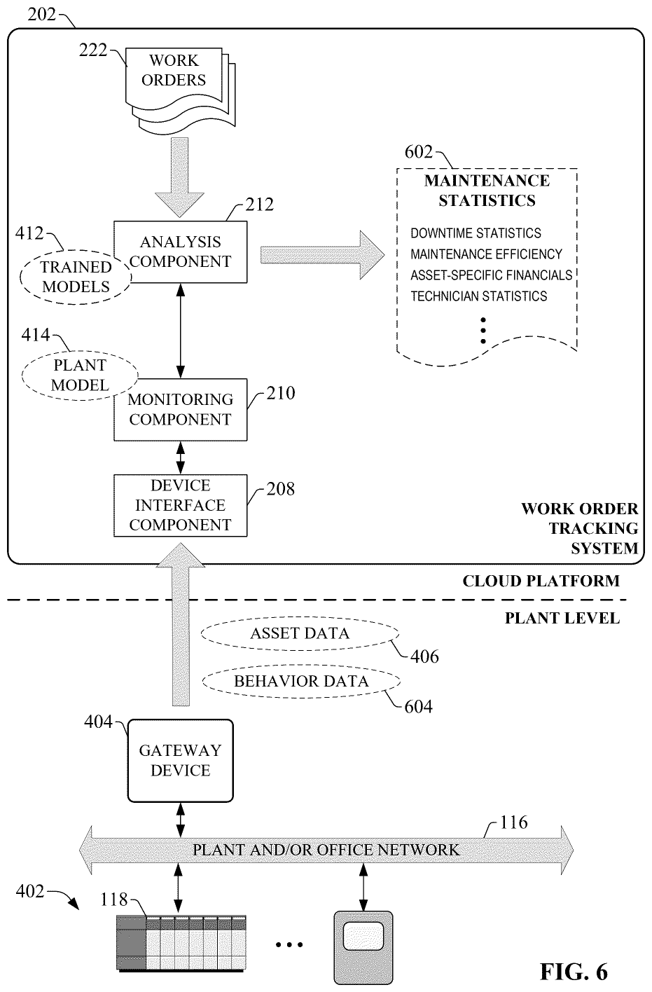

To assist with tracking of maintenance activities, as well as improving the effectiveness of those activities, embodiments of the work order tracking system 202 can analyze data from both closed (or historical) and open (or active) work orders 222 as well as information about the industrial assets on which maintenance is performed to determine a range of insights relating to the customer's asset performance and maintenance, and render these statistics in the form of maintenance reports and recommendations for improving maintenance efficiency. FIG. 6 is a diagram illustrating generation of maintenance statistics 602 that quantify an industrial enterprise's maintenance activities based on analysis of open and closed work orders 222 as well as historical or real-time asset data 406. The system's analysis component 212 can be trained to analyze content of work orders 222 and to generate various types of maintenance statistics 602 based on this analysis. The analysis component 212 can perform this analysis on overall maintenance activities performed for the enterprise to yield general statistics, on individual assets to yield asset-specific statistics, on activities performed by individual maintenance personnel to yield technician-specific statistics, or on specific types of maintenance activities to yield statistics on those activities. These statistics 602, can include, but are not limited to, machine or asset downtime statistics, maintenance efficiency statistics, asset-specific financial information, technician statistics, and other such insights.

If necessary, the analysis component 212 can leverage other information in connection with analyzing the work orders 222 and generating maintenance statistics 602, including but not limited to information about the industrial assets operated by the industrial enterprise (as obtained from plant model 414 or from another source of information regarding the customer's assets); information regarding the identities, roles, and skill sets of technicians employed by the industrial enterprise (as obtained from the enterprise's MES system as part of MES data 416, or from an employee database); behavior data 604 representing monitored technician behaviors, activities, or locations of the technicians; responses 506 prompted from a generative AI model 408 (if used); or other such supplemental data.

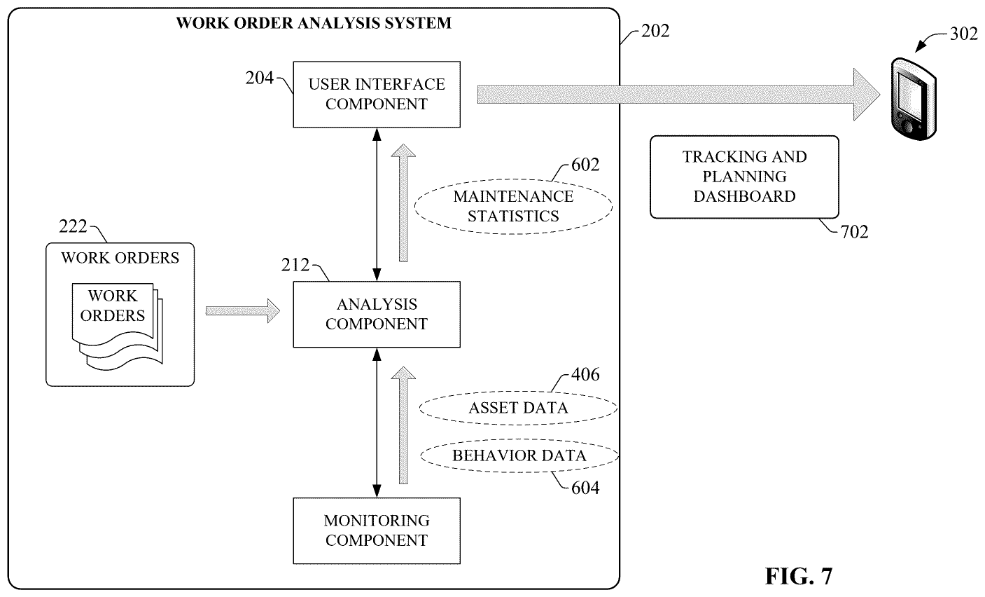

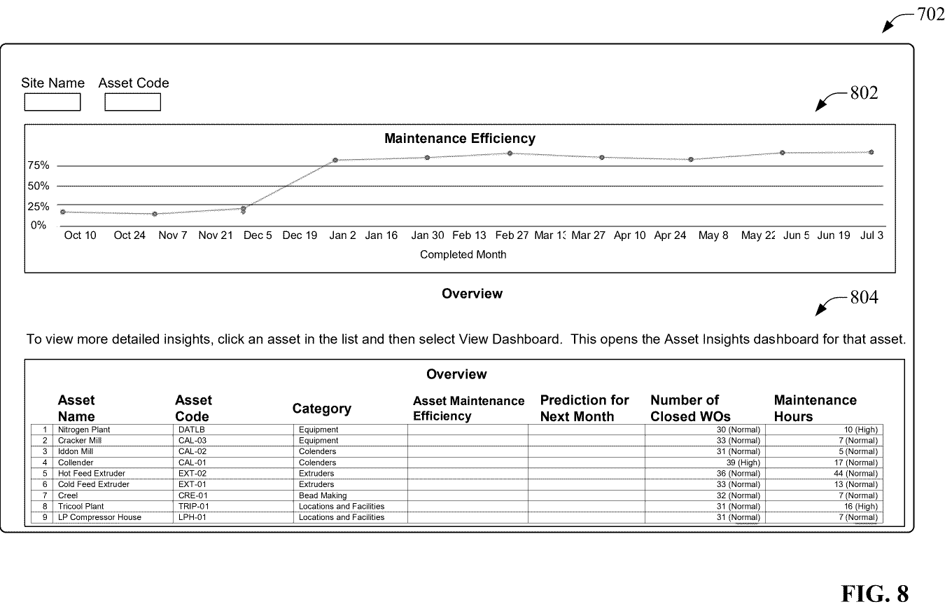

FIG. 7 is a diagram illustrating delivery of maintenance tracking and planning dashboards 702 to a client device 302 by the system 202. The system's user interface component 204 can render maintenance statistics 602 generated by the analysis component 212 via tracking and planning dashboards 702 that present the statistics 602 in graphical or alphanumeric formats. FIGS. 8-10 are example views of tracking and planning dashboards 702 that can be generated by the user interface component 204 and used to present selected maintenance statistics 602 generated by the analysis component 212. FIG. 8 is an example dashboard 702 that renders a plot 802 of calculated maintenance efficiency as a percentage over time, and an Overview section 804 that lists industrial assets on which maintenance was performed together with maintenance statistics for each asset. Plot 802 is a visual representation of average maintenance efficiency over time for a recent time frame (e.g., for the past 12 months). In some embodiments, the analysis component 212 can also predict a future trend of this maintenance efficiency based on analysis of the content of historical work orders 222 and any appropriate supplemental data (including training data 502 or responses 506 prompted from the generative AI model 408 for embodiments that support generative AI-assisted analysis), and the user interface can extend plot 802 into the future to convey this predicted future trend. The analysis component 212 can predict these future trends based on execution of the predictive models (part of trained models 412) on the collected asset data 406.

The asset-specific maintenance statistics displayed in the Overview section 804 include, for each asset, an asset code, a category (e.g., Equipment, Extruders, Colenders, etc.), a maintenance efficiency, a predicted efficiency for the subsequent month, a number of closed work orders 222 for the asset, a number of hours spent performing maintenance on the asset, or other such information.

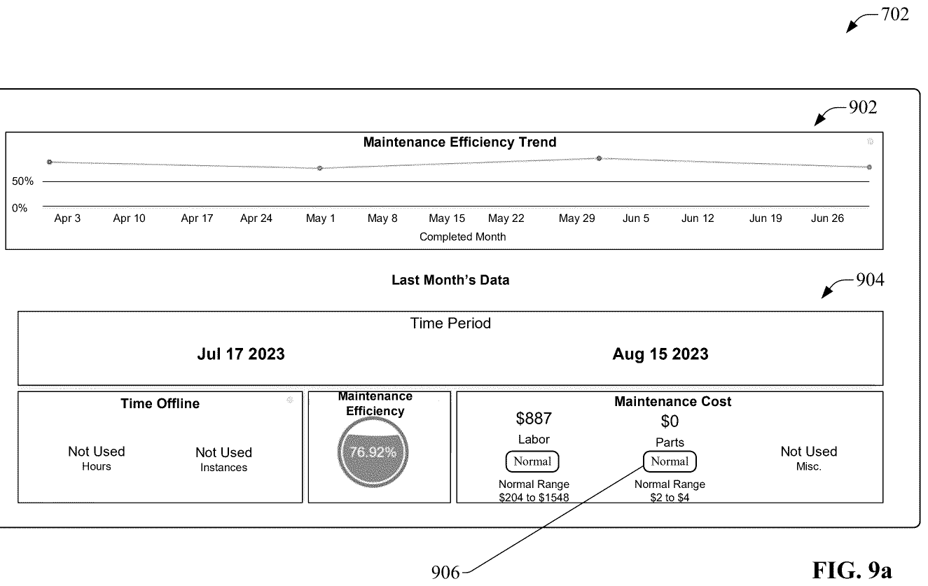

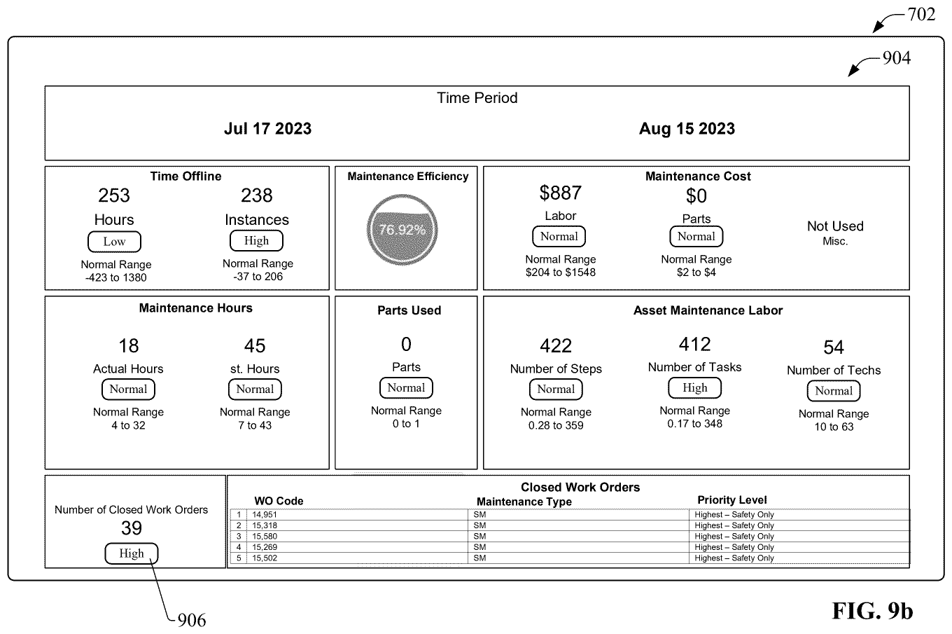

FIG. 9a is an example dashboard 702 that renders a plot 902 of a maintenance efficiency trend over time, and a portion of a Previous Month Summary section 904 that displays accumulated maintenance statistics for the previous month. FIG. 9b is another view of dashboard 702 that depicts more information included in the Previous Month Summary section 904. The dashboard views depicted in FIGS. 9a and 9b may display statistics for a selected single asset or machine, or may display aggregated statistics for multiple selected assets. In the case of asset-specific statistics, the dashboard 702 may display the asset name and asset code for the asset whose statistics are being displayed.

The maintenance efficiency plot 902 can represent a percentage of work orders 222 created via scheduled maintenance out of a total number of work orders for the asset. The plot 902 can include both historical calculated maintenance efficiency as well as a future trend in maintenance efficiency for the asset calculated by the analysis component 212. The Previous Month Summary section 904 can include, for the previous month or for a selected time period specified by the user, such information as the date range for which the statistics are being displayed, the number of total offline hours or instances experienced by the industrial asset; a maintenance efficiency; the total cost of maintenance performed on the asset (which can be categorized into labor costs, cost of parts, and miscellaneous costs); a total number of actual hours spent on maintenance activities for the asset together with an estimated number of hours expected to be spent on maintenance; a number of parts used to carry out maintenance activities on the asset; statistics on maintenance labor performed on the asset (which can include the number of individual steps performed, a number of tasks performed, and a number of technicians that were required to perform the maintenance tasks); the total number of work orders 222 that were closed for the asset during the specified time period; and a list of those closed work orders 222 that includes the work order code, the type of maintenance, and the priority level for each closed work order 222. The user interface component 204 can order the list of closed work orders 222 according to relative priorities of the closed work orders (e.g., the top ten work orders 222 having the highest priorities).

As shown in FIGS. 9a and 9b, a graphical indicator 906 can be rendered near each of the numerical statistics and can indicate whether the numerical value of its corresponding statistic is normal, high (above the normal or expected range), or low (below the normal or expected range). The value ranges considered normal for each statistic (which can also be displayed together with the actual value of the statistic) can be calculated by the analysis component 212 based on observed values of the statistics for previous months. In some embodiments, the user interface component 204 can be configured to generate a proactive alert in response to determining that any of the statistical measures displayed in FIGS. 9a and 9b have deviated from their normal values, ensuring that prompt action is taken to address the causes of the deviations.

In some embodiments, the analysis component 212 and user interface component 204 can update the statistical information displayed in the Previous Month Summary section 904 every month (or every 30 days), based on analysis of new or updated work orders 222, recent asset data 406, and updated training of the models 412. The dashboard can also allow a user to customize the date range of interest for the asset statistics, and the analysis component 212 will update the values of the maintenance statistics in accordance with the user's selected date range. The user can also schedule a day of the month on which a report for the previous month's maintenance statistics will be generated by the system 202.

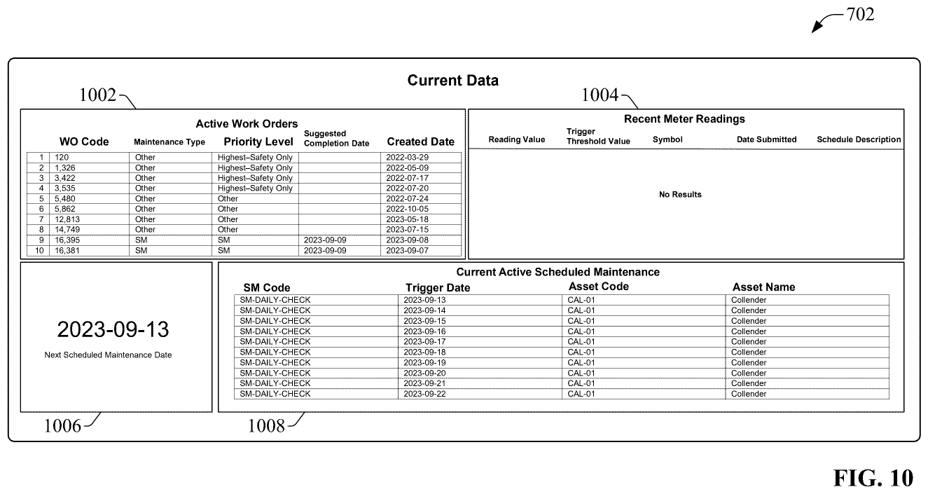

FIG. 10 is an example dashboard 702 that renders information on currently active or open work orders 222. As in the case of the Previous Month Summary section 904 illustrated in FIGS. 9a-9b, the information on current open or active work orders illustrated in FIG. 10 can be specific to a single selected asset or machine, or may be an aggregate of current information for multiple selected assets. Since the information presented in this view is for currently active work orders 222, the system 202 can update the information in this view more frequently than that rendered in the Previous Month Summary section 904 (e.g., every hour).

This view renders a list 1002 of active work orders 222, or a limited subset of the currently active work orders 222 selected for display based on one or more selection criteria (e.g., work order priority, suggested completion date, the date that the work order 222 was created, if the work order 222 is for scheduled maintenance rather than reactive maintenance, etc.) The list 1002 can also order the work orders 222 according to these selection criteria to assist technicians in prioritizing maintenance activities. The list 1002 displays, for each work order, the work order code, the type of maintenance to be performed, the priority level, the suggested completion date, and the date that the work order 222 was created. A meter reading window 1004 renders the most recent metered values for the asset submitted to the system 202 by technicians or read by the system 202 as part of asset data 406. Another window 1008 lists the currently scheduled maintenance activities in the order in which those activities are to be triggered, as determined from the information contained in the open work orders 222. Another window 1006 displays a date of a next scheduled maintenance activity for quick reference.

By providing single dashboard view that displays an ordered list of active work orders and corresponding maintenance tasks for an industrial asset, as well as recent metered data for the asset, the Current Data view of dashboard 702 can assist technicians in prioritizing the most crucial maintenance tasks and improve maintenance efficiency.

In some embodiments, the system 202 can recalculate or update the maintenance statistics 602, or respective subsets of the statistics 602, at defined maintenance reporting intervals. Embodiments of the system 202 that utilize predictive models to generate predictive insights into the customer's asset performance and maintenance can execute these predictive models at intervals that align with the system's maintenance reporting intervals. In this way, the system 202 can serve as a tool that assists customers in reviewing and optimizing their maintenance procedures.

As noted above, one or more of the trained models 412 for a given customer can be predictive models that are trained to forecast or predict future performance issues or failure risks for the industrial assets, to predict future asset performance trends, and to generate predicted maintenance statistics 602 for the customer's assets and plant operations. Since the work order tracking system 202 is a multi-tenant system that provides work order tracking, maintenance planning, and asset performance insights for multiple industrial customers having respective different collections of industrial assets and maintenance practices, the system 202 can maintain, train, and execute respective customer-specific predictive models for these different customers. Initially, when a customer begins using the system's maintenance planning and tracking services, the customer's initial predictive model can be pre-trained using a range of relevant domain-specific data that is not necessarily specific to the customer's asset operation and maintenance activities, such as knowledge or technical specifications of various industrial assets, machines, and devices; knowledge of various types of industrial verticals (e.g., automotive, mining, food and drug, pharmaceuticals, etc.); knowledge of various types of industrial applications; or other such training data 502. This initial training yields a predictive model that can be used by the analysis component 212 to generate predictive insights (in the form of predicted maintenance statistics 602) regarding the performance the customer's specific assets, to predict potential asset failures or performance degradations, and to generate work orders 222 and formulate optimized maintenance schedules based on these predictions. The system 202 is capable of generating these predictive insights and performing predictive maintenance scheduling automatically without the need for the customer to perform.

Over time, as customer-specific asset data 406 is collected by the system 202, the training component 216 can apply machine learning to retrain the customer-specific predictive model using this collected asset data 406. The system 202 can perform this retraining of the predictive model automatically based on actual monitored performance of the customer's industrial assets over time, as well as information obtained from work orders 222 that have been opened and executed for the respective assets. In this way, each customer's predictive model can learn trends in performance of the customer's various industrial assets, histories and frequencies of failures for the various assets, and other such customer-specific performance histories. The analysis component 212 can then use this re-trained predictive model to improve the accuracy of the predictive maintenance statistics 602 delivered to the customer and to improve the effectiveness and efficiency of maintenance schedules generated by the system 202. The training component 416 can automatically perform retraining of a customer's predictive model according to a periodic retraining schedule (e.g., by applying machine learning to an updated data set comprising any new asset data 406 that has been received since previous retraining) or in response to a defined retraining condition.

The system 202 can scale these predictive insight services across any number of industrial customers, training and re-training each customer's proprietary predictive model automatically over time by applying machine learning to the customer's proprietary asset data 406.

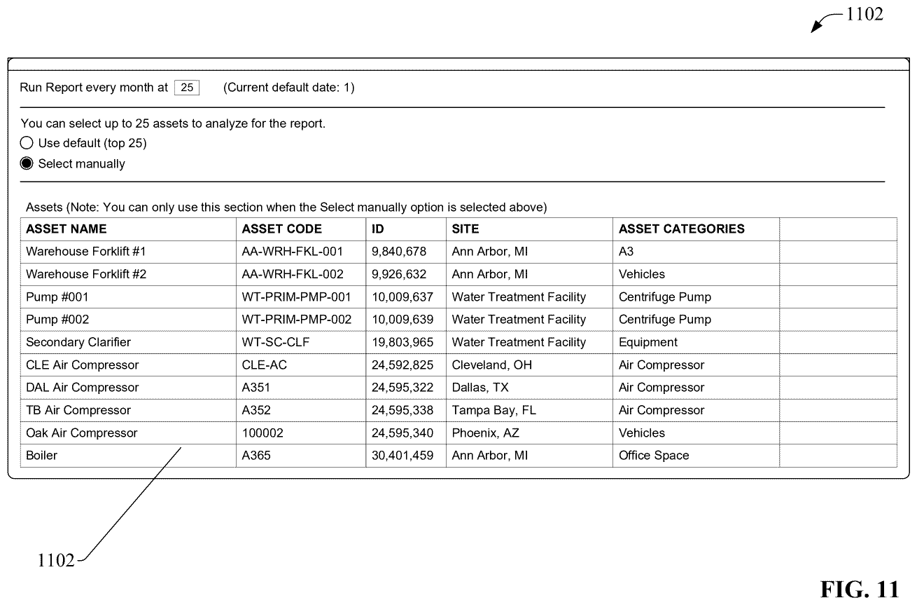

FIG. 11 is an example asset selection window 1102 that can be rendered by user interface component 204 and used to manually select assets whose maintenance statistics are to be tracked and displayed on dashboard 702 (e.g., for the monthly overview illustrated in FIG. 8). If desired, the user can allow the work order tracking system 202 to use default selection criteria that automatically select a subset of the customer's industrial assets whose maintenance statistics are to be tracked and displayed via dashboard 702. In an example scenario, the system 202 can select which assets are to be tracked be based on the number of work orders 222 opened for the respective assets, such that a subset of the customer's assets for which the highest number of work orders 222 were opened will be tracked and included in the monthly summary. In another example, the system 202 can select and prioritize an asset for tracking based on a determination that the asset data collected for the asset is indicative of a performance issue. When the system 202 selectively onboards an asset for tracking and sets a maintenance priority for the asset, the system 202 can also update any existing maintenance schedules in accordance with new asset's priority.

As an alternative to automated onboarding of industrial assets, the user may choose to manually select assets to be tracked and displayed by selecting assets of interest from a list of available assets displayed in an asset list 1104 displayed in window 1102. The user interface component 204 can populate this list based on information drawn from the work orders 222 maintained on the system 202. The asset selection list 1104 can display, for each candidate asset, a name of the asset, an asset code, a numerical identifier, a site or facility at which the asset resides, and an asset category to which the asset belongs (e.g., Vehicles, Pumps, Air Compressors, Equipment, etc.). Selection of a subset of assets from this list 1102 will configure the system 202 to include those assets on the Overview section 804 (see FIG. 8). A similar asset selection interface 1102 can be used to select an asset whose previous month's statistics (as shown in FIGS. 9a-9b) or current statistics (as shown in FIG. 10) are to be displayed.

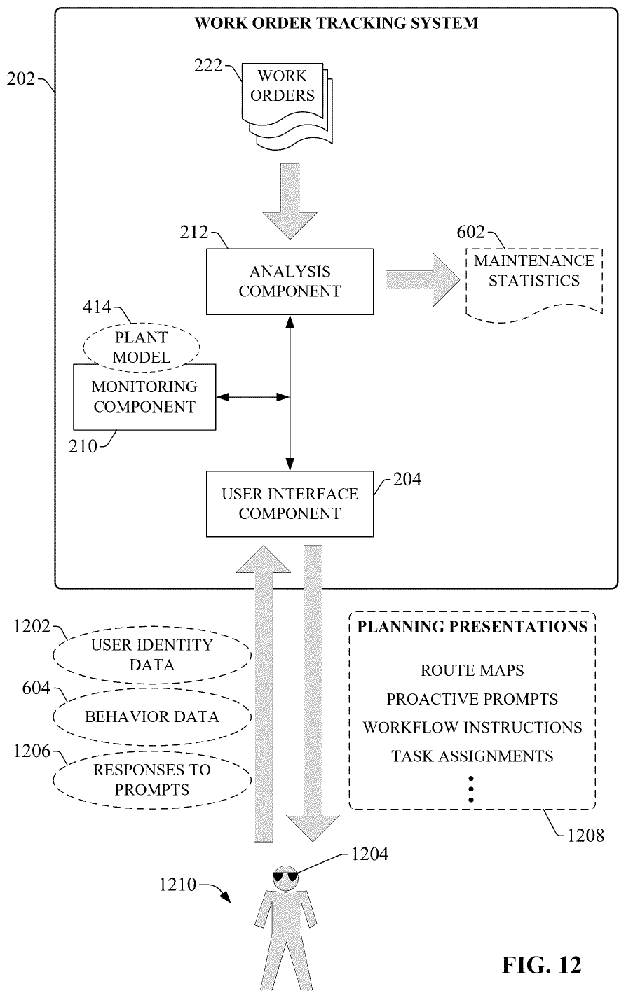

Some of the maintenance statistics 602 generated by the analysis component 212 may be based in part on the amount of time that was taken to carry out the maintenance tasks prescribed by the work orders 222. Statistics 602 that consider the measured time to complete respective maintenance tasks can include, for example, the number of hours spent on maintenance activities (including asset-specific maintenance hours, technician-specific maintenance hours, and total maintenance hours), maintenance efficiency, labor costs, or other statistics 602. To ensure accuracy of these statistics 602, the system can track the amount of time taken to carry out work orders 222 of different types. To this end, some embodiments of the work order tracking system 202 can monitor and track the locations and behaviors of technicians as they are performing the maintenance tasks prescribed by a work order 222. FIG. 12 is a diagram of an example architecture in which a technician's activities are tracked by the system 202. In the illustrated example, technician 1210 carries a trackable client device 1204 capable of generating data describing the technician's identity, location, and behaviors, and submitting this data to the work order tracking system 202 (e.g., via user interface component 204). Client device 1204 can be, for example, a wearable appliance such as an augmented reality headset worn by the technician and comprising a transparent or semitransparent viewing lens or screen through which the user views his or her surroundings, and which can render graphical or alphanumeric information at selected locations on the lens or screen, thereby overlaying information onto the user's field of view. Alternatively, the client device 1204 may be another type of work or carried personal device, such as a mobile phone or device with display capabilities.

As the technician 1210 is engaged in performing a maintenance task associated with a work order 222 to which the technician 1210 is assigned, the system's user interface component 204 can collect, from the technician's client device 1204, user identity data 1202 that uniquely identifies the technician 1210, as well as behavior data 604 describing at least the user's current location within the plant facility. In some embodiments, the behavior data 604 may also describe other technician behaviors that are observable by the client device 1204, including but not limited to the technician's manual activities as the technician is performing a maintenance task, natural language input recorded from the user's speech, or other such behaviors.

The system's monitoring component 210 can monitor this user identity data 1202 and behavior data 604 as the technician is engaged in a maintenance task, and use this information to track the amount of time that the technician takes to perform the task. In some embodiments, the monitoring component 210 can include, as part of the total maintenance time, the time taken by the technician 1210 to move to the industrial asset on which the maintenance task is to be performed. The analysis component 212 can record the total time required to perform the maintenance task, including this traversal time, as part of the maintenance statistics 602. This can yield more accurate maintenance time tracking relative to relying on manual time entries submitted by the technicians 1210.

Some embodiments of the work order tracking system 202 can also provide dynamic prompts or instructions to the technician in the form of presentations 1208 delivered to the technician's client device 1204. The monitoring component 210 can trigger these presentations 1208 and formulate the content to be rendered on the presentations 1208 based on the technician's monitored behavior data 604 and, when necessary, content of a relevant work order 222. In some embodiments, this architecture can be used to retroactively and dynamically generate work orders 222 based on the system's observations of the technician's activities. For example, based on real-time monitoring of the technician's behavior data 604, the monitoring component 210 may determine that the technician 1210 has spent an excessive amount of time near an industrial asset (e.g., an amount of time that exceeds a defined threshold indicative of an inferred interest in the asset). Based on this determination, the user interface component 204 can generate and deliver a presentation 1208 to the technician's client device 1204 containing a prompt asking the technician 1210 if a task is being performed on the asset. The technician 1210 can submit a response 1206 to this prompt via the client device 1204; e.g., as a spoken response translated to speech data by the client device 1204, or as a manually entered response. If the technician's response 1206 indicates that maintenance is being performed on the asset, the analysis component 212 can initiate a work order 222 for the task—prompting the technician 1210 for additional information about the task being performed if necessary—and retroactively add time to the work order 222 equal to the amount of time that the technician 1210 had spent near the asset (and, if appropriate, an amount of time taken by the technician 1210 to travel to the asset).

The analysis component 212 can populate this work order 222 with information obtained from various sources, including the identity of the asset on which the technician 1210 is performing maintenance (which may be obtained from the plant model 414 in embodiments that use such a model), the identity of the technician 1210 (obtained from the user identity data 1202), information about the maintenance task being performed (which may be determined by prompting the user for responses 1206 describing the task, or based on an inference of the task based on the technician's observed activities), information from closed work orders 222 for maintenance tasks determined to be similar to the task being performed by the technician 1210, or other relevant data.

After completion of a work order 222 (either a dynamically generated work order 222 as described above or a pre-scheduled work order 222), the system 202 can review for circumstances that may necessitate adding or removing time from the recorded amount of time taking to perform the task. For example, based on analysis of the user's location over time (obtained from behavior data 604), the monitoring component 210 may determine that the technician 1210 relocated to the break room in the middle of performing the task, or visited a store room to retrieve parts for another job after completion. The analysis component 2121 can determine that these time periods should not be included as part of the total time to complete the maintenance time and, accordingly, subtract or omit the time taken to perform these activities from the total amount of time for performing the maintenance task recorded in the maintenance statistics 602. The analysis component 212 can compare the actual time to complete a work order 222 with estimated times to complete the work order 222 in order to gauge performance, and can include results of this comparison as part of the statistical data rendered on the maintenance tracking and planning dashboards 702.

Some embodiments of work order tracking system 202 can also execute tools that assist managers and technicians in planning execution of open work orders 222 in a manner determined to optimize one or more maintenance metrics, or to satisfy one or more defined optimization criteria. In such embodiments, the analysis component 212 can determine work order execution strategies that at least one of maximize overall maintenance efficiency, minimize the total time to execute the open work orders 222, minimize labor costs associated with execution of the work orders 222, minimize the number of technicians required to complete the work orders 222, minimize the number of steps taken by the technicians to complete the work orders 222, or optimize other such factors. The analysis component 212 can formulate these strategies based on aggregate analysis of the work orders 222 themselves (including the identities of the assets to which the respective work orders 222 are directed, the type of maintenance to be performed, etc.) as well as other plant-specific information such as the locations of the industrial assets within the plant facility (which can be obtained from the plant model 414 or from another source of asset location information), technician schedule and skill set information (which can be obtained by the MES interface component 214 as part of MES data 416, or from another source of technician information), plant operating schedules or operating schedules for individual lines or assets, or other such data. In some embodiments, the analysis component 212 can also reference information contained in trained models 412 (or the training data 502 itself) in connection with formulating optimized strategies for executing open work orders 222.

The analysis component 212 can generate recommendations for execution of the open work orders 222 based on these determined strategies, and the user interface component 204 can render these recommendations on tracking and planning dashboards 702 (see FIG. 7) for review by managing personnel, or as a presentation 1208 delivered to a technician's client device 1204. These recommendations can include, for example, a recommended order in which to execute maintenance tasks prescribed by the open work orders 222, recommended technicians to be assigned respective tasks (e.g., based on a consideration of the technicians' skill sets as well as current or scheduled locations within the plant relative to the assets requiring maintenance), recommended days and times to perform the respective maintenance tasks, or other such recommendations.

In an example scenario in which the system 202 generates work order planning recommendations that are targeted to a specific technician 1210, the analysis component 212 can formulate and render, as a presentation 1208, a work order map that guides the technician's route and activities for the day in a manner determined to optimize the efficiency of the technician's maintenance activities, or to coordinate the technician's maintenance activities with those of other technicians in a manner that implements the higher level maintenance execution strategies formulated by the analysis component 212 as described above. For example, for a given work order 222, the analysis component 212 can determine an optimized route to be traversed by the technician when carrying out the work order 222. The analysis component 212 can determine this route based on knowledge of the locations of respective assets within the plant facility (as determined from the plant model 414 or another source of plant layout information) and the maintenance tasks to be performed as prescribed by the work order 222, as well as other considerations that improve the efficiency of the route (e.g., minimization of redundant stops, minimization of the number of steps required to traverse the route while still accomplishing all required maintenance tasks, etc.).

When formulating a technician's route, the analysis component 212 can also consider other open work orders 222 that define tasks that could be performed by the technician while on the route to execute the technician's work order 222 of interest. For example, the analysis component 212 may determine that the technician's route to execute a work order 222 on a first industrial asset will bring the technician near a second asset for which another work order 222 is currently active. Based on this determination, the analysis component 212 may formulate the technician's route to take the technician to this second asset either on the way to or on the way from the first asset. The user interface component 204 can render this route on presentation 1208 together with instructions for performing the required maintenance on both the first and second assets. In determining a technician's optimized route, the analysis component 212 may also consider whether the technician will have the necessary tools to carry out the required maintenance on the second asset; e.g., based on a determination of which tools the technician will have in his or her possession in order to carry out the required maintenance on the first asset.

The user interface component 204 can render an optimized route on a technician's client device 1204 in any suitable format, including but not limited to a graphical trajectory line overlayed on a map of the plant facility, an augmented reality (AR) presentation that renders symbols and text (e.g., arrows, icons, directional instructions, etc.) that guide the technician to the next stop on the route from the technician's present location, or other such formats.

If a work order 222 is to be carried out by multiple technicians, the analysis component 212 can schedule respective subsets of tasks defined by the work order 222 to each technician to optimize overall execution workflow. This can include, for example, selecting a technician to be designated to collect tools required for the task, designating tasks among the technicians, determining an order in which each technician is to make visits to respective stops along the maintenance route (e.g., the tool room, the asset site, etc.), or performing other such coordination. The user interface component 204 can render a presentation 1208 on each technician's client device 1204 that displays a description of the tasks to be performed by that technician, as well as the route to be traversed by the technician in connection with performing those tasks.

If appropriate, the analysis component 212 can update the maintenance statistics 602 for a given work order 222 based on any of the monitored technician behaviors observed during execution of the work order 222, as represented by the user identity data 1202, behavior data 604, and responses 1206 to prompts. This can include updating the number of maintenance hours spent working on the relevant asset, the maintenance efficiency, the maintenance cost (including both labor and parts cost), the number of steps or tasks performed by technicians in order to complete the maintenance tasks prescribed by the work order 222, to total number of technicians that were involved in competing the maintenance tasks, or other such statistics 602.

Embodiments of the work order tracking system 202 described herein can offer detailed insights into an industrial enterprise's maintenance practices and efficiencies, as well as performance of the enterprise's industrial assets as a function of those maintenance events. The system 202 can also provide guidance to technicians tasked with executing work orders, providing recommended orders of maintenance task execution and recommended maintenance routes determined to substantially optimize efficiency of asset maintenance.

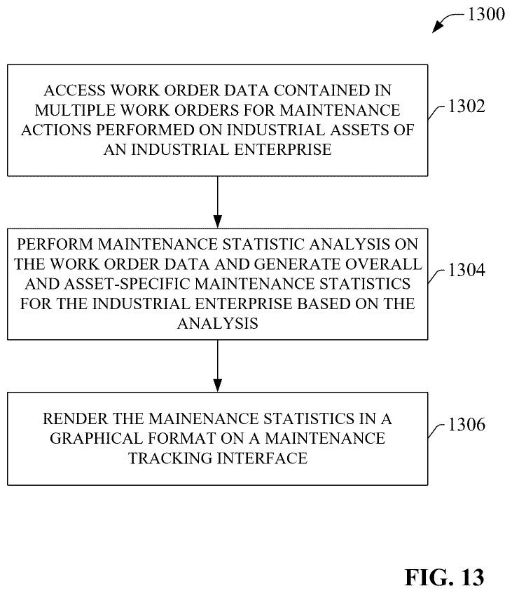

FIGS. 13-15 illustrate example methodologies in accordance with one or more embodiments of the subject application. While, for purposes of simplicity of explanation, the methodologies shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 13 illustrates an example methodology 1300 for tracking maintenance statistics within an industrial facility. Initially, at 1302, work order data is accessed, where this work order data is contained in multiple stored work orders for maintenance actions performed on industrial assets of an industrial enterprise. At 1304, statistical analysis is performed on the work order data, and maintenance statistics for the industrial enterprise are generated based on the analysis. These statistics can include overall maintenance statistics for the enterprise as a whole, asset-specific maintenance statistics for respective individual industrial assets, or overall statistics for a selected subset or group of assets. At 1306, the maintenance statistics generated at step 1304 are rendered in a graphical format on a maintenance tracking interface. Example maintenance statistics that can be derived from work order data in this manner can include, but are not limited to, maintenance efficiency, total maintenance hours spent on respective different industrial assets or machines, total numbers of work orders that were closed for the respective different assets or machines, total or asset-specific labor and part costs, total steps taken or tasks performed in connection with maintenance activities, or other such statistics.

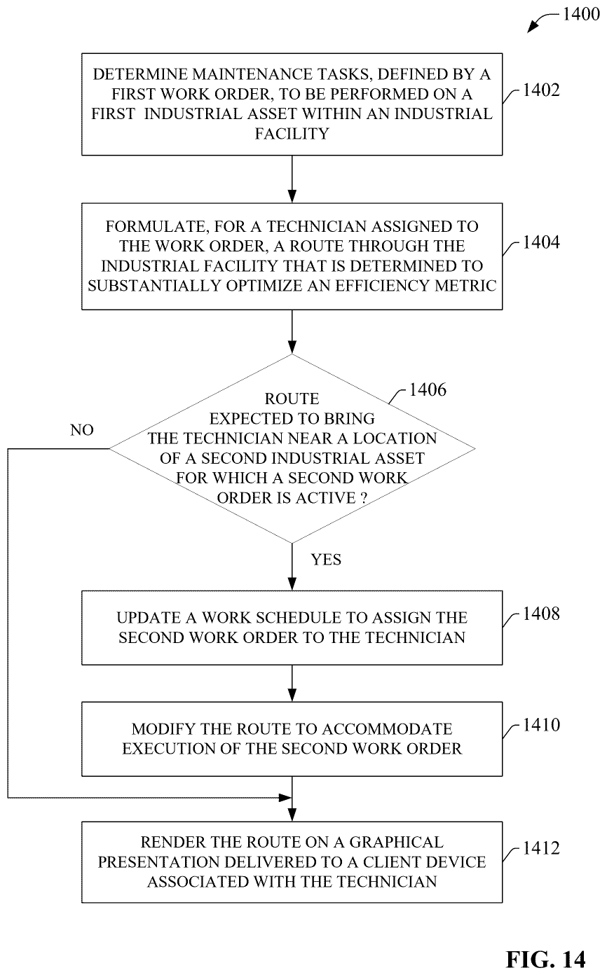

FIG. 14 illustrates an example methodology 1400 for planning and optimizing maintenance routes for technicians within an industrial facility. Initially, at 1402, a determination is made as to maintenance tasks, defined by a first work order, to be performed on a first industrial asset within an industrial facility. At 1404, for a technician assigned to the work order, a route through the industrial facility to be traversed by the technician in connection with performing the maintenance task is formulated such that the route substantially optimizes an efficiency or optimization metric or satisfies one or more defined optimization criteria (e.g., minimizes the total number of steps or total distance traversed by the technician, minimizes the total estimated time to complete the maintenance task, avoids potential delays in executing the maintenance, etc.). The route can be formulated based on plant layout information (e.g., as defined in a plant model or another source of information regarding the identities and locations of the industrial assets within the industrial facility), the nature of the maintenance to be performed, tools required to carry out the maintenance, or other such information. The route can be formulated to consider intermediate stops that the technician is expected to make on the way to the first industrial asset. This can include, for example, formulating the route to include a stop at a parts storage room to collect a spare part that will be required as part of the maintenance, a stop at a tool storage room to collect tools expected to be required to perform the maintenance, or other such intermediate stops.

At 1406, a determination is made as to whether the route formulated at step 1404 is expected to bring the technician near a location of a second industrial asset for which a second work order is active. If the formulated route will bring the technician near the second asset (YES at step 1406), the methodology proceeds to step 1408, where a work schedule is updated to assign the second work order to the technician. This can involve, for example, updating work schedule information on a work order tracking and planning system to reflect the assignment. At 1410, the route formulated at 1404 is modified as needed to accommodate the execution of the second work order by the technician (e.g., to add a stop at the second asset, to add a stop for additional tools required to execute the second work order, etc.). If the route is not expected to bring the technician near the second asset (NO at step 1406), steps 1408 and 1410 are skipped.

At 1412, the route formulated at step 1404 (and, if appropriate, modified at step 1410) is rendered on a graphical presentation delivered to a client device associated with the technician. In various example scenarios, the route can be rendered as a path line overlaid on a graphical map of the industrial facility, or may be conveyed to the user via augmented reality graphics that guide the technician along the formulated route.

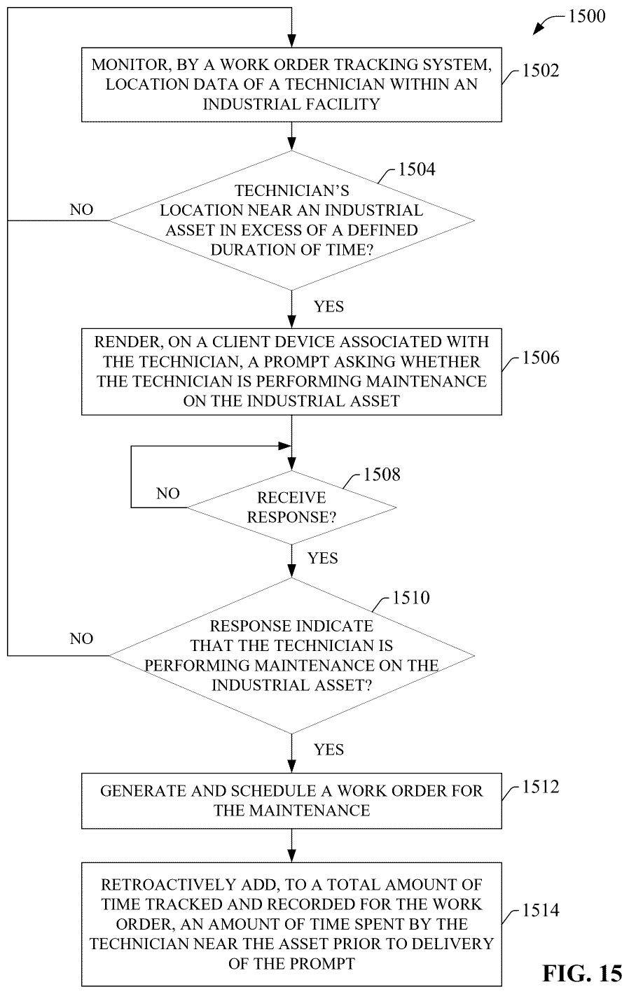

FIG. 15 illustrates an example methodology 1500 for automatically initiating a work order for maintenance being performed on an industrial asset and to retroactively track the cumulative time spent on the maintenance. Initially, at 1502, location data of a technician within an industrial facility is monitored by a work order tracking system. The technician's location can be monitored, for example, by tracking a location of the technician's personal client device. At 1504, a determination is made as to whether the technician's location has been near an industrial asset or machine within the industrial facility in excess of a defined duration of time. In an example embodiment, the work order tracking system can determine the technician's location relative to industrial assets within the facility based on plant layout information that defines the identities and locations of respective industrial assets or machines within the facility. This plant layout information can be recorded in a plant model or another data source. The system can cross-reference the technician's monitored location with this plant layout data to determine whether the technician has remained within a defined distance from one of the industrial assets for a duration of time that exceeds a threshold.

If the technician has been near the industrial asset in excess of the defined duration of time (YES at step 1504), the methodology proceeds to step 1506, where a prompt is rendered on a client device associated with the technician. The prompt asks the technician whether the technician is currently performing maintenance on the industrial asset. At 1508, a determination is made as to whether a response to this prompt is received from the technician's client device. If a response is received (YES at step 1508), the methodology proceeds to step 1510, where a determination is made as to whether the response indicates that the technician is performing maintenance on the asset. If the response does not indicate that the technician is performing maintenance (NO at step 1510), the methodology returns to step 1502 and monitoring of the technician's location continues. Alternatively, if the response indicates that the technician is performing maintenance on the asset (YES at step 1510), the methodology proceeds to step 1512, where the work order tracking system generates and schedules a work order for the maintenance being performed on the asset. If required, the system can deliver addition prompts to the technician's client device requesting additional information about the maintenance for inclusion in the work order, such as the nature of the maintenance being performed. At 1514, an amount of time spent by the technician near the asset prior to delivery of the prompt at step 1506 is retroactively added to a total amount of time being tracked and recorded for the work order created at step 1512.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors-electronic integrated circuits that perform logic operations employing electric signals-configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

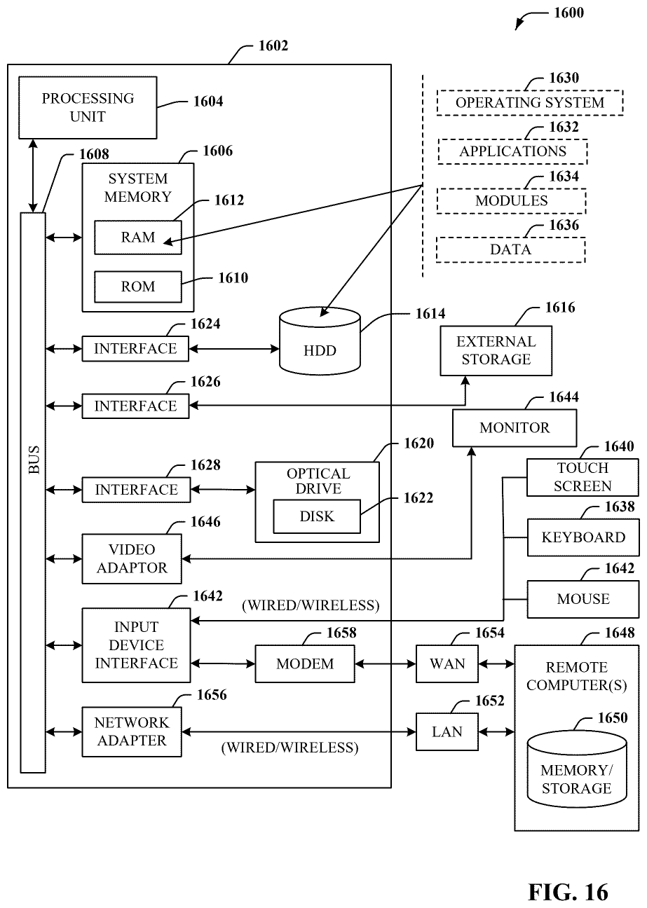

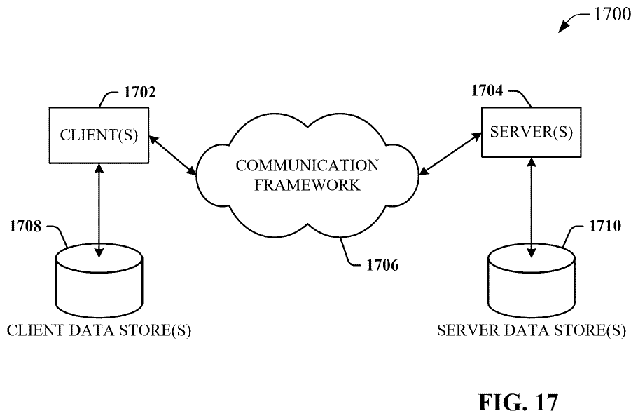

In order to provide a context for the various aspects of the disclosed subject matter, FIGS. 16 and 17 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16 the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for application programs 1632. Runtime environments are consistent execution environments that allow application programs 1632 to run on any operating system that includes the runtime environment. Similarly, operating system 1630 can support containers, and application programs 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1644 or other type of display device can be also connected to the system bus 1608 via an interface, such as a video adapter 1646. In addition to the monitor 1644, a computer typically includes other peripheral output devices (not shown), such as speakers, printers, etc.

The computer 1602 can operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1652 through a wired and/or wireless communication network interface or adapter 1656. The adapter 1656 can facilitate wired or wireless communication to the LAN 1652, which can also include a wireless access point (AP) disposed thereon for communicating with the adapter 1656 in a wireless mode.

When used in a WAN networking environment, the computer 1602 can include a modem 1658 or can be connected to a communications server on the WAN 1654 via other means for establishing communications over the WAN 1654, such as by way of the Internet. The modem 1658, which can be internal or external and a wired or wireless device, can be connected to the system bus 1608 via the input device interface 1642. In a networked environment, program modules depicted relative to the computer 1602 or portions thereof, can be stored in the remote memory/storage device 1650. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1652 or WAN 1654 e.g., by the adapter 1656 or modem 1658, respectively. Upon connecting the computer 1602 to an associated cloud storage system, the external storage interface 1626 can, with the aid of the adapter 1656 and/or modem 1658, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 17 is a schematic block diagram of a sample computing environment 1700 with which the disclosed subject matter can interact. The sample computing environment 1700 includes one or more client(s) 1702. The client(s) 1702 can be hardware and/or software (e.g., threads, processes, computing devices). The sample computing environment 1700 also includes one or more server(s) 1704. The server(s) 1704 can also be hardware and/or software (e.g., threads, processes, computing devices). The servers 1704 can house threads to perform transformations by employing one or more embodiments as described herein, for example. One possible communication between a client 1702 and servers 1704 can be in the form of a data packet adapted to be transmitted between two or more computer processes. The sample computing environment 1700 includes a communication framework 1706 that can be employed to facilitate communications between the client(s) 1702 and the server(s) 1704. The client(s) 1702 are operably connected to one or more client data store(s) 1708 that can be employed to store information local to the client(s) 1702. Similarly, the server(s) 1704 are operably connected to one or more server data store(s) 1710 that can be employed to store information local to the servers 1704.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components and work order data defining work orders for maintenance tasks performed on industrial assets within an industrial facility; and
a processor, operatively coupled to the memory, that executes the executable components, the executable components comprising:
a monitoring component configured to, for a work order of the work orders, monitor a duration of time spent by a technician to execute a maintenance task defined by the work order;
an analysis component configured to record the amount of time in association with the work order as part of the work order data, and to generate maintenance statistic data for the industrial assets based on analysis of the work order data from the work orders; and
a user interface component configured to render, on a client device, an interface that displays the maintenance statistic data in a graphical format.

2. The system of claim 1, wherein
the monitoring component is further configured to monitor industrial asset data generated by the industrial assets, the industrial asset data comprising operational and status information for the industrial assets,
the executable components further comprise a training component configured to train a predictive model using the industrial asset data, and
the analysis component is configured to generate, as part of the maintenance statistic data, predicted maintenance statistics for the industrial assets based on execution of the predictive model.

3. The system of claim 2, wherein the analysis component is configured to execute the predictive model according to an execution cycle that coincides with a maintenance reporting interval of the system.

4. The system of claim 1, wherein
the monitoring component is further configured to monitor industrial asset data generated by the industrial assets, the industrial asset data comprising operational and status information for the industrial assets,
the analysis component is configured to, in response to determining that the industrial asset data satisfies a defined criterion indicative of a performance issue with an industrial asset of the industrial assets:
assign a maintenance priority to the industrial assets based on the performance issue, and
modify one or more maintenance schedules for the industrial assets based on the maintenance priority.

5. The system of claim 1, wherein the maintenance statistic data comprises at least one of overall maintenance efficiency, a number of work orders performed on respective different industrial assets, a number of maintenance hours spent on the respective different industrial assets, a cost of labor spent on the maintenance tasks, a cost of parts spent on the maintenance tasks, a number of steps performed to complete the maintenance tasks, or a number of technicians required to perform the maintenance tasks.

6. The system of claim 1, wherein the monitoring component is configured to monitor a location of the technician over time,
identify, based on the location over time, durations of time that the technician spends on activities other than the maintenance task, and
omit the durations of time from the amount of time recorded in association with the work order.

7. The system of claim 1, wherein
the analysis component is further configured to formulate, based on information about the maintenance task defined in the work order and plant layout data defining identities and locations of industrial assets within the industrial facility, a recommended route through the industrial facility to be traversed by the technician that satisfies an optimization criterion, and
the user interface component is configured to render the route on the client device.

8. The system of claim 1, wherein
the monitoring component is further configured to monitor industrial asset data generated by the industrial assets, wherein the industrial asset data comprises operational and status information for the industrial assets,
the analysis component is configured to, in response to determining that a subset of the industrial asset data satisfies a condition indicative of a current or predicted risk to an industrial asset of the industrial assets, formulate one or more maintenance tasks predicted to mitigate the current or predicted risk, and
the executable components further comprise a work order generation component configured to, in response to the determination by the analysis component that the subset of the industrial data satisfies the condition, generate a work order prescribing the one or more maintenance tasks.

9. The system of claim 8, wherein
the analysis component is further configured to determine an order of execution of the maintenance tasks that satisfies an optimization criterion, and
the user interface component is configured to render the order of execution on the interface.

10. The system of claim 1, wherein
the monitoring component is further configured to monitor a location of the technician over time, and
the analysis component is configured to, in response to determining, based on the location, that the technician has been within a defined distance of an industrial asset for a duration of time that exceeds a defined duration, instruct the user interface component to render a prompt on the client device requesting confirmation that the technician is engaged in a maintenance activity on the industrial asset.

11. The system of claim 8, wherein the executable components further comprise a work order generation component configured to, in response to receipt of a response to the prompt confirming that the technician is engaged in the maintenance activity, generate and schedule a work order for the maintenance activity.

12. The system of claim 9, wherein the analysis component is further configured to add, to a tracked amount of time spent performing the maintenance activity recorded in the work order, a duration of time equal to or based on an amount of time for which the technician was within the defined distance of the industrial asset prior to receipt of the response to the prompt.

13. A method, comprising:
storing, by a system comprising a processor, work orders for maintenance tasks performed on industrial assets within an industrial facility;
for a work order of the work orders, monitoring, by the system, a duration of time spent by a technician to execute a maintenance task defined by the work order;
recording, by the system, the amount of time in association with the work order as part of the work order data;
generating, by the system, maintenance statistic data based on analysis of the work order data; and
rendering, by the system on a client device, an interface that displays the maintenance statistic data in a graphical format.

14. The method of claim 13, wherein the maintenance statistic data comprises at least one of overall maintenance efficiency, a number of work orders performed on respective different industrial assets, a number of maintenance hours spent on the respective different industrial assets, a cost of labor spent on the maintenance tasks, a cost of parts spent on the maintenance tasks, a number of steps performed to complete the maintenance tasks, or a number of technicians required to perform the maintenance tasks.

15. The method of claim 13, wherein the recording of the amount of time comprises:
monitoring a location of the technician over time,
identifying, based on the location over time, durations of time that the technician spends on activities other than the maintenance task, and
omitting the durations of time from the amount of time recorded in association with the work order.

16. The method of claim 13, further comprising:
formulating, by the system based on information about the maintenance task defined in the work order and plant layout data defining identities and locations of industrial assets within the industrial facility, a route through the industrial facility to be traversed by the technician that satisfies an optimization criterion, and
rendering, by the system, the route on the interface.

17. The method of claim 13, further comprising:
monitoring, by the system, industrial asset data generated by the industrial assets, wherein the industrial asset data comprises operational and status information for the industrial assets; and
in response to determining that a subset of the industrial asset data satisfies a condition indicative of a current or predicted risk to an industrial asset of the industrial assets:
formulating, by the system, one or more maintenance tasks predicted to mitigate the current or predicted risk; and
generating, by the system, a work order prescribing the one or more maintenance tasks.

18. The method of claim 17, further comprising:
determining, by the system, an order of execution of the one or more maintenance tasks that satisfies an optimization criterion; and
rendering, by the system, the order of execution on the interface.

19. A non-transitory computer-readable medium having stored thereon instructions that, in response to execution, cause a system comprising a processor to perform operations, the operations comprising:
storing work orders for maintenance tasks performed on industrial assets within an industrial facility;
for a work order of the work orders, tracking a duration of time spent by a technician to execute a maintenance task defined by the work order;
recording the amount of time in association with the work order as part of the work order data;
generating maintenance statistic data based on analysis of the work order data; and
rendering, on a client device, an interface that displays the maintenance statistic data in a graphical format.

20. The non-transitory computer-readable medium of claim 19, wherein the maintenance statistic data comprises at least one of overall maintenance efficiency, a number of work orders performed on respective different industrial assets, a number of maintenance hours spent on the respective different industrial assets, a cost of labor spent on the maintenance tasks, a cost of parts spent on the maintenance tasks, a number of steps performed to complete the maintenance tasks, or a number of technicians required to perform the maintenance tasks.
